(19) United States
(12) Patent Application Publication
(10) Pub. No.: US 2011/0214107 A1
(43) Pub. Date: Sep. 1, 2011

(54) METHOD AND SYSTEM FOR TESTING GRAPHICAL USER INTERFACES

(75) Inventors: Tal Barmeir, Herzliya (IL); Guy David Arieli, Kadima (IL)

(73) Assignee: Experitest, Ltd., Herzliya (IL)

(21) Appl. No.: 12/715,111

(22) Filed: Mar. 1, 2010

(51) Int. Cl. G06F 11/36

(52) U.S. Cl. 717/125

(57) ABSTRACT

A method for testing and monitoring a graphical user interface (GUI) comprises capturing a screenshot of the GUI; extracting at least one graphical element from the screenshot of the GUI; generating a test script based on at least one action and at least one parameter assigned to the at least one extracted graphical element; executing the test script to test at the least functionality and visual of the at least one extracted graphical element; and reporting the test results.

### TECHNICAL FIELD

This invention generally relates to test automation of software applications, and more specifically to testing of graphical user interfaces of applications under test.

### BACKGROUND OF THE INVENTION

One of the stages in developing software applications is the quality assurance (QA) of the end product. Typically, this stage includes generating and executing scripts for testing different scenarios related to the execution of software applications. Such testing scenarios are mainly designed to validate and verify that a software application meets the business and technical requirements that guided its' design and development, and that it works as expected.

Conventional automated testing tools, such as WinRunner and QuickTest Professional (QTP) by Hewlett-Packard®, simply record a typical business process by emulating user actions (e.g., click an item). In most cases, the recording and execution are performed in the user interface (UI) control layer of the operating system. To this end, the internal UI or operating system should identify the graphical elements to be tested. As UIs are implemented using different technologies (e.g., Swing, Web, PowerBuilder, etc.), this requires the operating system to identify the graphical elements regardless of the technology. As a result, non-standard elements are not identified. Furthermore, the test will have limited indications on the appearance of the tested UI and of its layout. This is a limiting factor, as tests cannot be reusable to repeat throughout an application's lifecycle. As a result, the time and cost for developing new applications or new versions thereof is increased.

Furthermore, conventional testing tools are inefficient in testing player based UI technologies, e.g., elements that are based on Flash, Flex, Silverlight, animation, and the like. Such types of elements are heavily being used in electronic games, social networks applications, and other web based applications. As the market of such elements is exponentially growing, the disability of existing tools to efficiently test GUIs of such applications is a major drawback.

It would be, therefore, advantageous to provide a solution for testing software applications without imposing the limitations discussed above.

### SUMMARY OF THE INVENTION

Certain embodiments of the invention include a method for testing and monitoring a graphical user interface (GUI). The method comprises capturing a screenshot of the GUI; extracting at least one graphical element from the screenshot of the GUI; generating a test script based on at least one action and at least one parameter assigned to the at least one extracted graphical element; executing the test script to test at the least functionality and visual of the at least one extracted graphical element; and reporting the test results.

Certain embodiments of the invention further include an automated testing system testing. The system comprises an extraction module for receiving a screenshot of a graphical user interface (GUI) and extracting at least one graphical element from the screenshot of the GUI; a script generator for generating a test script based on at least one action and at least one parameter assigned to the at least one extracted graphical element; an execution module for executing the test script to test at least functionality and visual of the at least one extracted graphical element; and a scanning module for scanning the screenshot for one or more graphical elements respective of the at least one extracted graphical element during the execution of the test script

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a flowchart illustrating a process for testing and monitoring GUIs of software applications implemented according to an embodiment of the invention;

FIGS. 2A through 2D are screenshots illustrating certain embodiments of the invention;

FIG. 3 is a flowchart illustrating the operation of a strict scanning function as implemented in accordance with an embodiment of the invention;

FIG. 4 is a flowchart illustrating the operation of a contrast scanning function as implemented in accordance with an embodiment of the invention; and

FIG. 5 is a block diagram of a testing system provided in accordance with an embodiment of the invention.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

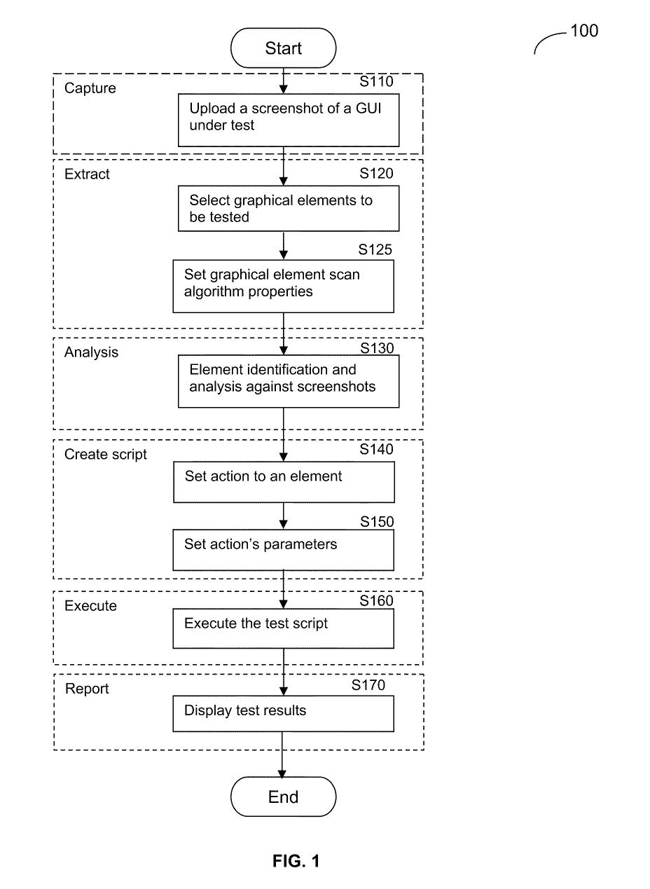

FIG. 1 shows a non-limiting and exemplary flowchart 100 illustrating the process for testing and monitoring a graphical user interface (GUI) of software applications implemented according to an embodiment of the invention. The process is designed to test any GUI that includes any type of graphical elements regardless of their appearance attributes (e.g., color, size, etc). A graphical element is an object, such as a character, an image, a sketch, and the like. A graphical element may be set with one or more properties including, for example, a name, an action, a scanning function, action's parameters, scanning function's parameters, and so on. The various scanning capabilities disclosed in accordance with certain embodiments of the invention will be described in greater detail below. Elements of the same type can be grouped to create a group of elements.

The GUI under test is a window (i.e., a rectangular part of a computer screen that contains a display different from the rest of the screen) or a section in the window. The testing performed by the disclosed method allows achievement of a visual testing (i.e., testing graphical elements in the GUI under test are rendered as expected) and a functionality test (i.e., testing that the actions associated with graphical elements properly function). Examples for such actions include click-element, drag-element, right-click-element, and the like.

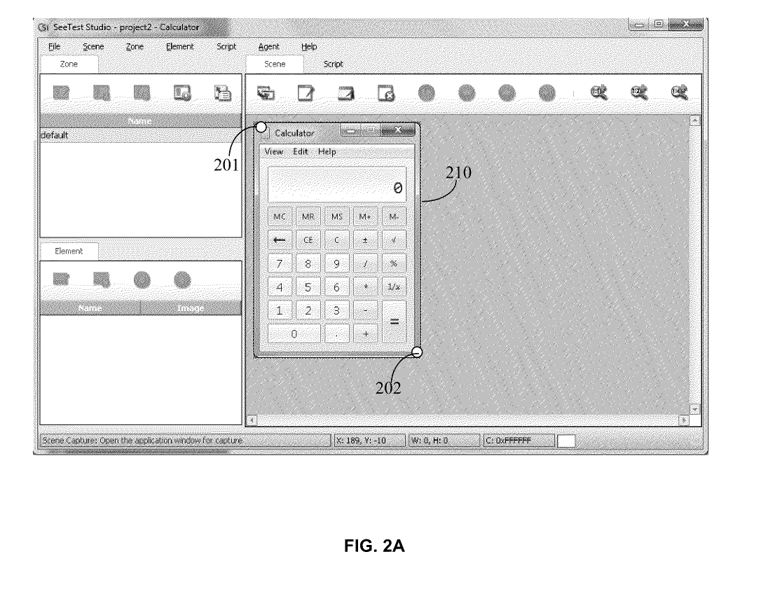

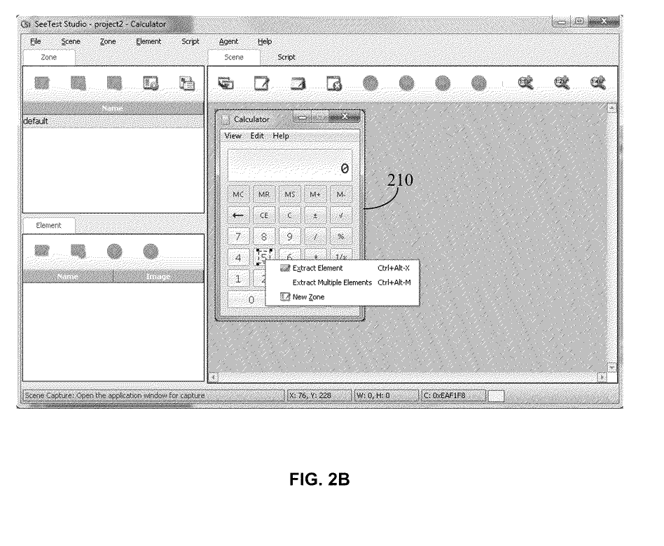

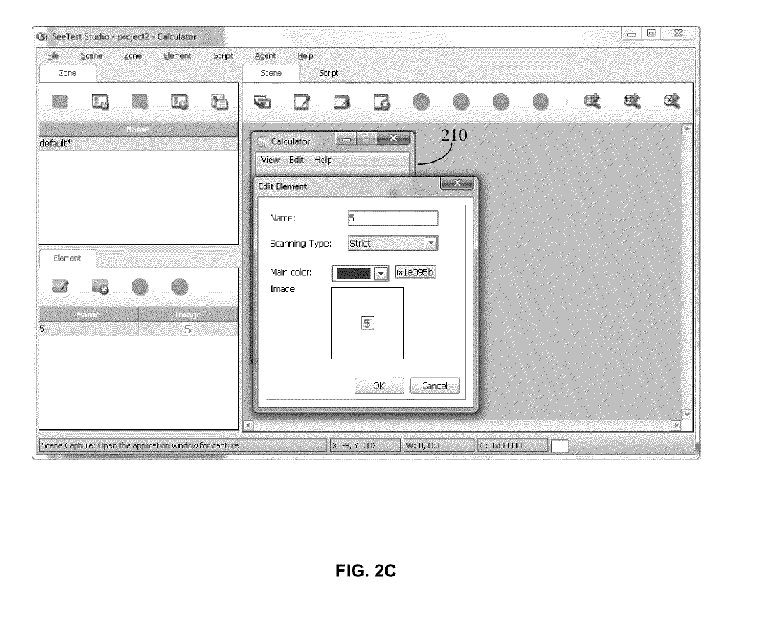

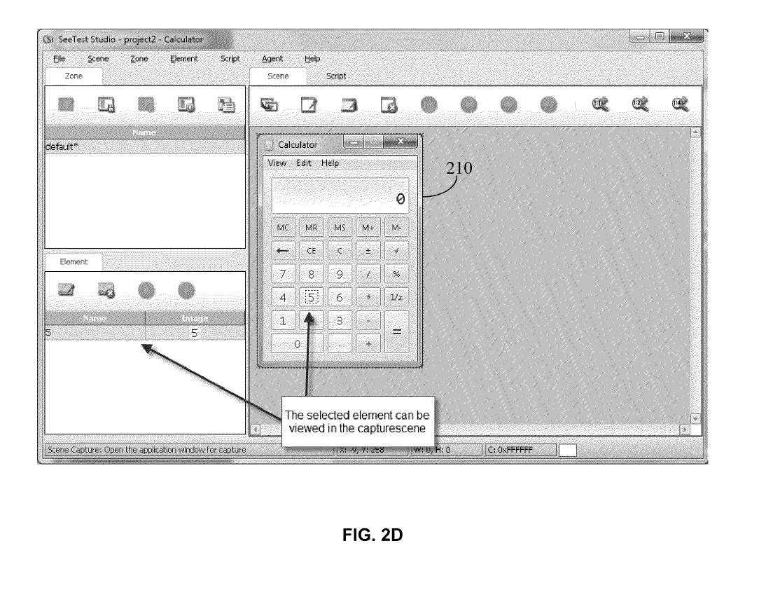

At S110, one or more screenshots of the GUI under test are captured and uploaded to a testing system. An exemplary screenshot 210 of an application “calculator” to be tested in shown in FIG. 2A. Next, a sub-process for extracting graphical elements to be tested is performed. Specifically, at S120, one or more graphical elements to be tested in a screenshot are selected. The graphical elements may be of different types or of the same type with different colors. Preferably, the user may also select the main color of each element. Optionally, if the user does not select the element's main color, then an automatic selection process is performed for setting the color with a highest pixel count within the boundaries of a selected graphical element to be the element's main color. As shown in FIG. 2B the user selects the graphical element “5” in the screenshot 210.

At S125, for each selected graphical element, one or more scanning functions are defined. A scanning function allows finding, in the screenshot of the GUI under test, one or more graphical elements respective of the selected element. For example, if the selected graphical element is a red-colored button image, then a scanning function can detect a red-colored button as well as button images with different colors, different sizes, and so on. The scanning functions are executed during runtime of a test script.

In accordance with certain embodiments of the invention, strict scanning, similarity scanning, and contrast scanning functions are disclosed. The strict scanning function allows for discovering a graphical element in the screenshot that matches a selected element, while performing a minimum pixel compare count. With this aim, the screenshot is scanned pixel-by-pixel according to a prioritized order. The similarity scanning function allows for detecting graphical elements that are similar to an input graphical element. The user can set this function with a plurality of parameters that define the sensitivity of the scanning. These parameters include, for example, a level of color change in the different area within the element, a level of a size change, and so on. The contrast scan function enables detection of graphical elements with unknown element and background colors. The scanning functions are designed to accelerate the execution of test scripts. A detailed description of each of the scanning functions is provided below. As depicted in FIG. 2C, the user can define for the selected graphical element “5”, the scanning type, the main color, and can assign a unique name to the element.

Once a graphical element is selected and the scanning function (type) is defined, the element is extracted. At S130, each extracted element is displayed in a list of input graphical elements to be tested, thereby enabling the user to verify the extracted elements against the screenshot. An example of such a list is labeled as “220” and shown in FIG. 2D.

At S140, for each input graphical element, an action to be tested is set. For example, if the input graphical element is a red-colored button, then the action may be a test command “click-element”. An action can be performed on a combination of a number of elements. Thus, in an embodiment of the invention, an action can be set on two or more graphical elements and during the runtime (i.e., when a test script is being executed), the testing process 100 composes these elements and performs the defined actions thereon.

At S150 for each action to be tested one or more parameters are defined. For example, if the action is “click-element”, then the parameter may be the number of times to click the element. The outcome of S140 and 150 are command lines respective of the set actions and parameters. The command lines are part of a test script. In one embodiment, the command lines are a form of pseudo code, which may be converted to any programming or scripting code including, but not limited to, Java, C-sharp, C++, Python, Ruby, and the like.

At S160, the generated test script is executed to test the visual and functionality of the input graphical elements in the GUI under test. Specifically, during the execution of S160, the scanning functions and composition process are performed, thereby enabling testing of graphical elements that appear differently than the input graphical elements. At S170, a report containing the test results is generated and displayed to the user.

The scanning functions are performed during S130 and the execution of the test script (S160). Generally a scanning function is executed using a pixel-by-pixel approach, starting, for example, from the top left pixel in the screenshot down and right to the bottom right pixel. For example, in the screenshot illustrated in FIG. 2A, the scanning starts at the pixel labeled as “201” through pixel “202”. Other embodiments will be apparent to one of ordinary skill in the art. In addition, the scanning functions implement a cache mechanism for accelerating the search. This includes, saving the location in the screenshot for each identified graphical element, and for subsequent scans for the same element, starting the scanning function from the saved location.

Each of the scanning functions mentioned above receives as an input the captured screenshot, the graphical elements to be searched for, and the coordinates of the location to start the scan. The outputs of the scanning function may include indication whether or not an input element was found and the location of the elements in the screenshot (if found).

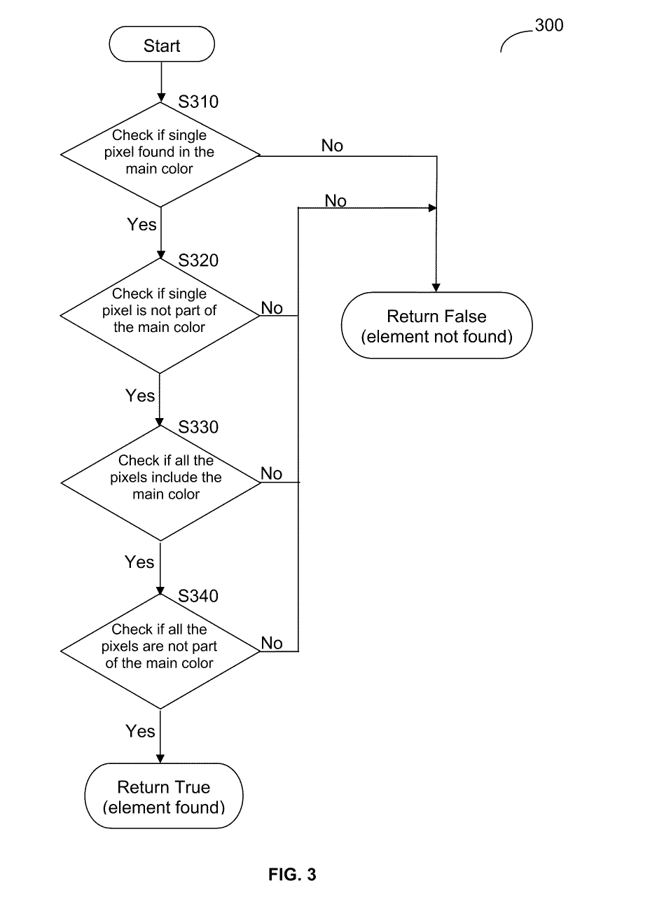

The strict scanning function searches pixel-by-pixel to detect an input element in the screenshot. The target of this function is to identify a false match with minimal number of checks. With this aim, a set of prioritized comparisons is performed. The strict scanning function is depicted in FIG. 3 where a non-limiting flowchart 300 showing the execution of this function is provided.

An input graphical element is divided into two groups of pixels: one group may include pixels with the main color and the other group pixels with a background color. The prioritized order of comparisons includes: checking if a single pixel is found in the main color group (S310); checking if a single pixel is not part of the main color group (S320); checking if all the pixels (excluding the pixel checked in S310) are in the main color group (S330); and checking if all the pixels (excluding the pixel checked in S320) are not part of the main color group, i.e., in the background color group (S340). If one of the checks results with a No answer, execution returns an indication that the input graphical element is not found in the input screenshot; otherwise, execution returns an indication that the input graphical element is found.

The similarity scanning algorithm is used for detecting graphical elements that are similar to an input graphical element, usually due to application look-and-feel changes. Every pixel in the input element is assigned with a score that is based on one or more factors. Such factors include, but are not limited to, a distance from the center of the element (e.g., pixels closer to the center assigned with a higher score) and the difference between a pixel's color and a background color (e.g., a pixel having a color as the background color is assigned with a lower score). Other embodiments to define such factors will be apparent to one with ordinary skill in the art.

Thereafter, the input element's pixels are sorted according to their scores, where a pixel with the highest score is the first in the list, thereby creating a sorted list of pixels. One or more watermarks are then defined in the sorted list. For example, a first watermark is defined after 10 pixels, a second watermark in the middle of list, and the last watermark at the end of the list. For each watermark a maximum similarity score is calculated as the sum of all the pixels scores in the watermark. Then, an allowed tolerance (TR) is calculated by multiplying a user similarity factor by the maximum similarity score. The user similarity factor is a predefined parameter. For example, if the maximum similarity score is 40 and the user similarity factor is 90%, the tolerance value is: TR=(1−0.9)*40=4.

During runtime, i.e., execution of S160, a distance color factor (DCF) is calculated for every pixel in the ordered list of pixels, starting at the pixel with the highest score. In one embodiment of the invention the DFC is computed as follows:

$$D C F = \frac{\sqrt{{dr}^{2} + {dg}^{2} + {db}^{2}}}{\sqrt{{256}^{2} \times 3}}$$

where, dr, dg, and db are respectively the red distance, green distance, and blue distance between two pixels. For example, assuming the RGB colors of two pixels (one in the ordered list and the other in the input screenshot) are as follows:

Pixel 1: Red: 120, Green: 100, Blue: 80

Pixel 2: Red: 110, Green: 100, Blue: 70

Then, dr=10, dg=0, and db=10 and the value of DCF is 14/444=0.031

Subsequently, the DCF computed for a pixel is multiplied with its score. The result of this multiplication is being summed with multiplication results of other pixels in ordered the list. When a new result is added to the sum, the new sum value is compared to the computed tolerance, and if the new sum value is above the tolerance value, an indication that an element is not found is returned; otherwise, once all pixels in the ordered list have been checked, execution returns an indication that the input graphical element is found.

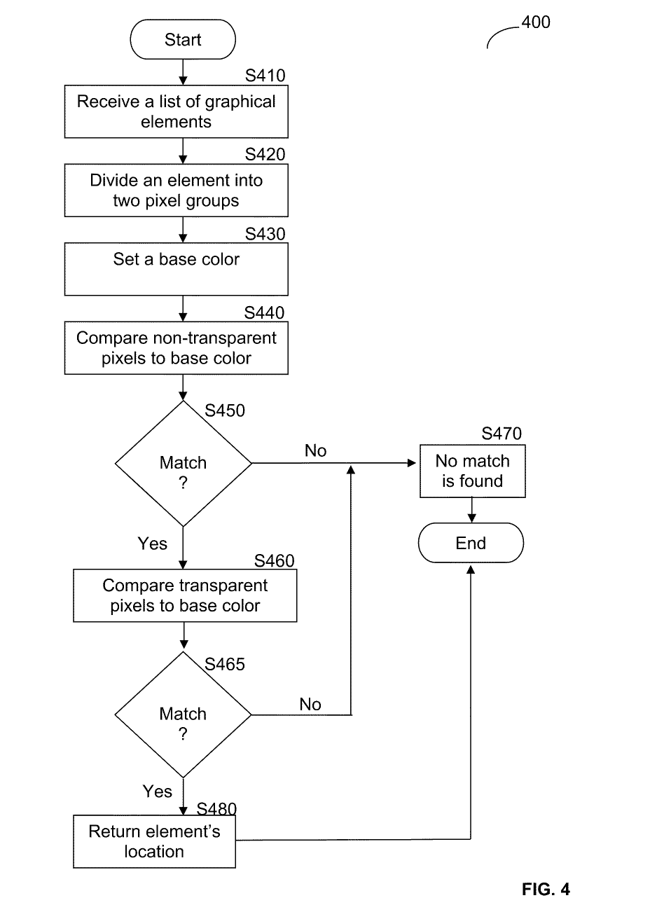

FIG. 4 shows an exemplary flowchart 400 illustrating the operation of the contrast scanning function implemented in accordance with an embodiment of the invention. At S410, a list of graphical elements with unknown main and background colors contained in the screenshot is received. At S420, each graphical element is divided into two pixel groups, one containing pixels with transparent color and the other pixels with non-transparent color. At S430, a pixel from the non-transparent group of pixels is selected and its color is set to be a base color. At S440, all pixels in the non-transparent group of pixels are compared to the base color, each pixel at a time. Then, at S450, it is checked if each pixel matches the base color, and if so execution continues with S460; otherwise, at S470, an error message indicating that an element is not found is returned. A transparent color indicates that the pixel will be ignored.

At S460, all pixels in the transparent group of pixels are compared to the base color, each pixel at a time. Then, at S465, it is checked if each pixel does not match the base color. If so, an element is found, and at S480 the location of the element is returned; otherwise, execution proceeds with at S470, where an error message indicating that an element is not found is returned.

It should be apparent to one of ordinary skill in the art that the scanning functions described herein allow testing of graphical elements that do not exactly match graphical elements appearing in the screenshot. For example, if a new version of a GUI is designed with look-and-feel different from previous versions, there is no need to create new test scripts in order to validate the new GUI.

During the execution of the test script a composition process is also performed, depending on the user selection of this option. This process includes scanning for the first element in a target graphical element, and once found, scanning for the next element in the target graphical element in the vicinity of the first element. In an embodiment of the invention, the vicinity of the search is a rectangular area around the detected first element. The length of this area is 2*AH and the width is character count multiplied by (2*AW), where AH is the first element height and AW is the first element width. As an example, if the target graphical element is the text OK, first, the element (letter) O is searched and once found, the rectangular area around the element ‘O’ is scanned for elements (letters) K.

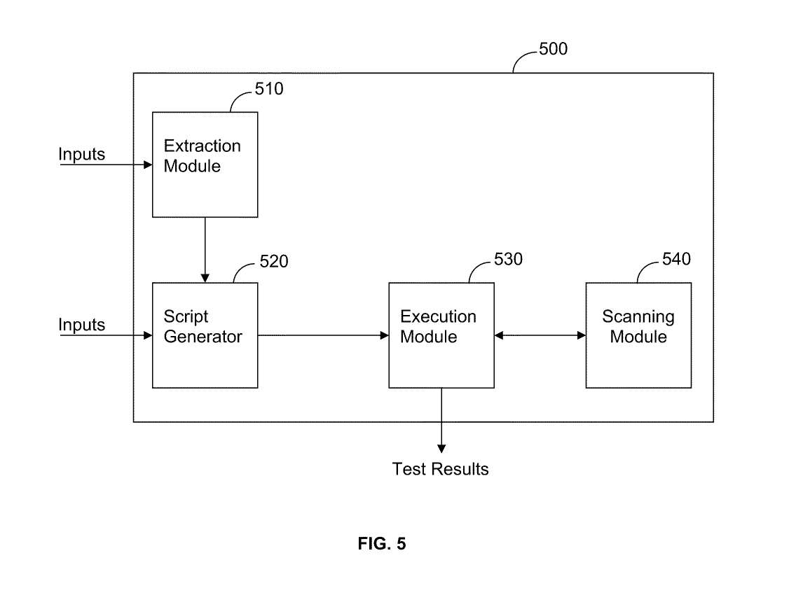

FIG. 5 shows an exemplary and non-limiting block diagram of an automated testing system 500 provided in accordance with an embodiment of the invention. The testing system 500 may be implemented as executable code (e.g., a script) and/or a firmware stored in a readable medium in computer hardware, or any combination thereof. The testing system 500 may be executed over the computer, which may be any computing device including at least a processor and a computer readable medium.

The testing system 500 includes an extraction module 510, a script generator 520, an execution module 530, and a scanning module 540. The extraction module 510 receives user's inputs including selection of graphical elements to be tested and one or more screenshots of the GUI under test. The extraction module 510, for each input graphical element, extracts all graphical elements with the same main color as the input element. The extracted elements are displayed to user enabling the user to set for extracted element at least actions to be tested, and scanning function or functions to perform during the testing. These settings together with identifications of the respective graphical elements are input to the script generator 520 that generates a test script based on the settings and the graphical elements to be tested. The test script may be any programming language. Once the script is created, the execution module 530 executes the test scripts and reports to the user on the testing results. During execution, the module 530 interfaces with the scanning module 540 that performs the scanning functions described in detail above. In addition, the execution module 530 carries out a composition process in order to test the visual and functionality of graphical elements composed from other elements.

The principles of the invention are implemented as any combination of hardware, firmware and software. Moreover, the software is preferably implemented as an application program tangibly embodied on a program storage unit or computer readable medium. One of ordinary skill in the art would recognize that a “computer readable medium” is a medium capable of storing data and can be in a form of a digital circuit, an analogy circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interlaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The foregoing detailed description has set forth a few of the many forms that the invention can take. It is intended that the foregoing detailed description be understood as an illustration of selected forms that the invention can take and not as a limitation to the definition of the invention.

1. A method for testing and monitoring a graphical user interface (GUI), comprising:
capturing a screenshot of the GUI;
extracting at least one graphical element from the screenshot of the GUI;
generating a test script based on at least one action and at least one parameter assigned to the at least one extracted graphical element;
executing the test script to test at the least functionality and visual of the at least one extracted graphical element; and
reporting the test results.

2. The method of claim 1, wherein extracting the at least one graphical element further comprises:
selecting on the screenshot the at least one graphical element to be extracted; and
setting a scanning function for searching in the screenshot for one or more graphical elements respective of the at least one extracted graphical element, wherein the scanning function is performed during the execution of the test script.

3. The method of claim 2, further comprises:
assigning a unique name to the at least one extracted graphical element; and
selecting a main color of the at least one extracted graphical element.

4. The method of claim 2, wherein the scanning function includes any one of a strict scanning function, a similarity scanning function, and a contrast scanning function.

5. The method of claim 4, wherein the strict scanning function discovers one or more graphical elements in the screenshot that match the at least one extracted graphical element.

6. The method of claim 4, wherein the similarity scanning function discovers one or more graphical elements in the screenshot that are similar to the at least one extracted graphical element.

7. The method of claim 4, wherein the contrast scanning function detects one or more graphical elements in the screenshot with unknown main and background colors.

8. The method of claim 4, wherein any of the strict scanning function, the similarity scanning function, and the contrast scanning function performs a pixel-by-pixel scanning.

9. The method of claim 1, further comprises testing functionality and visual of a composed graphical element.

10. The method of claim 9, further comprises:
setting a composition option to two or more extracted graphical elements;
setting at least one action to a composed graphical element consisting two or more elements respective of the two or more extracted graphical elements; and
during execution of the test script composing the two or more extracted graphical elements and testing the functionality and visual of the composed graphical element.

11. The method of claim 10, further comprises:
scanning the screenshot to detect two or more graphical elements respective of the at least two or more extracted graphical elements during the execution of the test script.

12. The method of claim 1, is executed by computer executable code stored in computer readable medium.

13. An automated testing system testing, comprising:
an extraction module for receiving a screenshot of a graphical user interface (GUI) and extracting at least one graphical element from the screenshot of the GUI;
a script generator for generating a test script based on at least one action and at least one parameter assigned to the at least one extracted graphical element;
an execution module for executing the test script to test at least functionality and visual of the at least one extracted graphical element; and
a scanning module for scanning the screenshot for one or more graphical elements respective of the at least one extracted graphical element during the execution of the test script.

14. The system of claim 13, wherein the execution module further generates a report including the test results.

15. The system of claim 13, wherein extracting the at least one graphical element further comprises:
selecting on the screenshot the at least one graphical element to be extracted; and
setting a scanning function for searching in the screenshot for one or more graphical elements respective of the at least one extracted graphical element, wherein the scanning function is performed during the execution of the test script.

16. The system of claim 15, wherein the scanning function includes any one of a strict scanning function, a similarity scanning function, and a contrast scanning function.

17. The system of claim 16, wherein any of the strict scanning function, the similarity scanning function, and the contrast scanning function performs a pixel-by-pixel scanning.

18. The system of claim 13, wherein the execution module further testes functionality and visual of a composed graphical element.

19. The system of claim 18, further comprises:
setting a composition option to two or more extracted graphical elements;
setting at least one action to a composed graphical element consisting two or more elements respective of the two or more extracted graphical elements; and
during execution of the test script composing the two or more extracted graphical elements and testing the functionality and visual of the composed graphical element.

20. The system of claim 19, further comprises:
scanning the screenshot to detect the two or more graphical elements respective of the at least two or more extracted graphical elements during the execution of the test script.
